(19) United States
(12) Patent Application Publication
(10) Pub. No.: US 2023/0213487 A1
(43) Pub. Date: Jul. 6, 2023

(54) Fingerprint Detection Method for Pharmaceutical Preparation

(71) Applicant: Shaanxi Buchang Pharmaceutical Co., Ltd, Xianyang City, Shaanxi (CN)

(72) Inventors: Zhishu Tang, Xianyang City (CN); Feng Liu, Xianyang City (CN); Yanru Liu, Xianyang City (CN); Gang Xu, Xianyang City (CN); Wei Xie, Xianyang City (CN); Zhongxing Song, Xianyang City (CN); Yanbin Chen, Xianyang City (CN); Jian Zhang, Xianyang City (CN); Rui Su, Xianyang City (CN); Chao Zhao, Xianyang City (CN)

(21) Appl. No.: 18/008,854

(22) PCT Filed: Jun. 15, 2020
(86) PCT No.: PCT/CN2020/096105

§ 371 Date: Dec. 7, 2022

(51) Int. Cl. G01N 30/06; G01N 30/88

(52) U.S. Cl. CPC G01N 30/06; G01N 30/88

(57) ABSTRACT

A fingerprint detection method for a pharmaceutical preparation. The detection method uses an HPLC-DAD wavelength switching method to simultaneously determine a plurality of active ingredients such as mulberroside A, hydroxysafflor yellow pigment A, paeoniflorin, ferulic acid, calycosin-7-O-β-D-glucoside, rosmarinic acid, salvianolic acid B, formononetin, etc. in the pharmaceutical preparation. The sensitivity and accuracy of the detection method are greatly enhanced so as to ensure the comprehensive evaluation of the quality of the pharmaceutical preparation.

### TECHNICAL FIELD

The present invention relates to the field of detection and analysis of pharmaceutical components, in particular to a fingerprint detection method for pharmaceutical formulation.

The representative pharmaceutical formulation of the present invention is Naoxintong capsules, which is composed sixteen herbs such as astragalus, Paeonia rubra, Salvia miltiorrhiza, Chinese angelica, rhizome of chuanxiong, peach kernel, safflower, frankincense, myrrh, spatholobus stem, achyranthes root, cinnamon twig, mulberry twig, Pheretima, scorpion and leech. The pharmaceutical preparation of the present invention is an exclusive invention of Shaanxi Buchang Pharmaceutical Co., Ltd. and included in the 2015 edition of “Chinese Pharmacopoeia” for the treatment of cardiovascular and cerebrovascular diseases, nourishing qi and promoting blood circulation, removing blood stasis and dredging collaterals, treating for qi deficiency and blood stagnation, stroke caused by blood stasis, hemiplegia, numbness of limbs, slanted mouth and eyes, inarticulateness, chest impediment, chest tightness, palpitations, brachypnea, cerebral infarction, coronary heart disease and angina pectoris. The drug is used in the treatment and prevention of heart and brain diseases which has unique advantages in clinical efficacy and safety, and has been recognized and praised by a large number of patients. The applicant has previously applied for multiple patents for the product: the associated patent numbers are CN 01128760.8, CN 200410040805.5, CN 200510041654.x, CN 200510042657.5, CN 200610042977.5, CN 200810183946.0, CN 20131310077615.6, CN 20131310077615.6. The above patents focus on prescriptions, production processes, formulations, quality control methods, and new clinical uses. The current implementation standard of this product meet the requirement of the State Food and Drug Administration Standard WS-10001 (ZD-0001)-2002, and only paeoniflorin, tanshinone IIA, and salvianolic acid B should be determined under the existing standard. The quality control indicators of the three components are few and relatively weak; at the same time, three different detection methods are used in the existing standards to detect paeoniflorin, tanshinone IIA, and salvianolic acid B. The detection process is cumbersome and time-consuming. Since the Chinese medicine preparation described in this invention is made of multiple Chinese medicines, its single internal control index component cannot carry out all quality control indexes on the whole process of the production, nor does it conform to the overall synergistic effect of Chinese medicine, therefore, it is particularly necessary to adopt a multi index testing method for quality control.

The prior art documentation is analyzed for the system search finishing of the “Pharmaceutical preparation content” measurement method of the present invention, which mainly includes: high performance liquid chromatography, thin layer identification, etc. Wang Yubao, determination of salviae in the pharmaceutical formulation of this invention by high performance liquid chromatography published on Intentional Cerebrovascular Diseases, 2008 May 25, which used 0.5% glacial acetic acid-methanol (93:7) as mobile phase to determine the content of salvianic acid in the pharmaceutical formulation of this invention by high performance liquid chromatography. Su Hang, He Jianbo et. al, published in Hebei Medicine, 2015 Mar. 10, descripted HPLC fingerprint study and component determination of the pharmaceutical formulation of the invention. In the article, the efficacy of this pharmaceutical formulation by gradient elution was evaluated by acetonitrile-0.6% phosphoric acid aqueous solution as the mobile phase, and fingerprint analysis was established by HPLC method for determining the concentration of astragaloside, calycosin-7-glucoside, salvianolic acid B, and hydroxysafflor yellow A in this formulation for quality control.

Zhang Shengjie, Wang Li, et al., published their study in the Journal of China Pharmaceutical University, 2019 Oct. 25: The simultaneous determination of 7 index components in the pharmaceutical formulation of the present invention by HPLC wavelength switching method. In the study, the authors established the HPLC-DAD wavelength switching method (240,280,316, 403 nm) and used methanol-acetonitrile (25:75, A)-0.1% formic acid aqueous solution (B) as the mobile phase for the simultaneous determination of the seven index components in this pharmaceutical preparation. The concentrations of seven index components, including hydroxysafflor yellow A, paeoniflorin, ferulic acid, salvianolic acid B, kaempferol, formononetin and tanshinone IIA, were determined in the pharmaceutical formulations of this invention. However, the above-mentioned concentration determining methods are still cumbersome and the active ingredients selected in the above-mentioned quality standard system cannot be used to evaluate the quality of proprietary Chinese medicine.

In recent years, the fingerprint spectrum technology of Chinese medicine has been developed to reflect the types and amounts of chemical substances in Chinese medicine in a more comprehensive manner, and to systematically characterize the quality control and product stability of Chinese medicine preparations. In addition, the fingerprint spectrum can accurately quantify a number of index components, especially the active ingredients, which makes the quality control of Chinese medicine more accurate and can more truly reflect the quality condition of Chinese medicine, making the quality and stability of the products more reliable.

Contents of the Invention

The purpose of the present invention is to provide a method for fingerprint spectroscopy of pharmaceutical formulation. The invention uses ultra performance liquid chromatography (UPLC) technology to establish a method for simultaneous detection of quality marker components in the pharmaceutical formulation of the invention that are closely related to drug efficacy, which not only enhances the detection efficiency, but also greatly improves the quality control of the pharmaceutical formulation of the invention and ensure the effectiveness of the products.

Specifically, the method is based on the systematic fingerprint quantification method, and the main wavelengths 230, 254, 280, 324 and 400 nm of each single herb are selected from the chromatogram (190-400 nm) obtained by the diode array detector (DAD). The pharmaceutical formulation of the present invention contains multiple active ingredients such as mulberroside A, hydroxysafflower yellow A, paeoniflorin, ferulic acid, calycosin-7-glucoside, rosmarinic acid, salvianolic acid B, and formononetin and the sensitivity and accuracy of the detection method are greatly enhanced to ensure the comprehensiveness of the quality evaluation of the pharmaceutical formulation of the present invention.

The pharmaceutical composition and preparation method of this invention comprises: astragalus 66 g, red peony root 27 g, Salvia miltiorrhiza 27 g, Chinese angelica 27 g, Rhizome of chuanxiong 27 g, peach kernel 27 g, safflower 13 g, frankincense 13 g, myrrh 13 g, spatholobus stem 20 g, achyranthes root 27 g, cinnamon twig 20 g, mulberry twig 27 g, pheretima 27 g, scorpion 13 g, leech 27 g. The preparation method comprises taking pheretima and scorpion milled into fine powder, andthe other 14 ingredients, such as astragalus, milled into a fine powder, and the above powders are sieved and mixed together. The pharmaceutical formulation of the present invention is not limited to the Naoxintong capsules, but also includes other Chinese herbs similar to astragalus, red peony root, Salvia miltiorrhiza, Chinese angelica, Rhizome of chuanxiong, peach kernel, safflower, spatholobus stem, achyranthes root, pheretima, scorpion, leech, etc.

The pharmaceutical preparation of the present invention is added with pharmaceutical acceptable excipients to form a formulation, such as: capsules, tablets, oral liquids, pills, granules, etc.

The method provided by the present invention for the determination of the content of pharmaceutical formulation is as follows.

A method for fingerprint spectral detection of a pharmaceutical formulation, characterized in that the steps comprise:

(1) preparation of a test solution: taking and mixing an appropriate amount of the ingredients of the invention, adding 65-75% methanol for extraction, ultrasonic treating, shaking well, filtering to obtain a filtrate and a pellet, the pellet washing with 65-75% ethanol for several times, combining the ethanol washing solution into the filtrate, evaporating the filtrate, the pellet resolving with 65-75% ethanol and diluting to a scale, shaking well, filtering to obtain the test solution,

(2) preparation of the mixed standard solution: precise weighing of paeoniflorin, salvianolic acid B, hydroxysaffron yellow A, mulberroside A, tanshinone IIA, ferulic acid, rosmarinic acid, calycosin-7-glucoside and formononetin in an appropriate amounts to obtain a mixture, adding methanol to solve the mixture to obtain the mixed standard solution,

(3) liquid chromatographic conditions: filling a chromatographic column with octadecylsilane bonded silica gel, using 0.2% formic acid (A solution)—acetonitrile (B solution) as the mobile phase, setting a gradient elution procedure containing steps of 0 to 2 min in 2% B solution, following 2 to 7 min in 2%˜14% B solution, 7 to 9 min in 14%˜15% B solution, 9 to 11 min in 15%˜16% B solution, 11 to 14 min in 16%˜35 35% B solution, 14 to 16 min in 35% B solution, 16 to 21 min in 35%-70% B solution, 21 to 23 min in 70% B solution, 23 to 28 min in 70%-100% B solution, 28 to 30 min in 100% B solution, volume flow 0.1-0.4 ml/min, column temperature 30-35° C., and detection wavelength 230-300 nm; and

(4) determination of chromatographic peaks: using the test solution and the standard solution obtained from steps (1) and (2) and the condition descripted in step (3), recording the chromatographic peak within 35 minutes.

Preferably, the extraction solution concentration used in the described step (1) is 70% methanol.

Preferably, in the preparation of the mixed standard solution in the step (2), the concentration of mulberroside A being 5.05-37.86 μg·mL⁻¹, the concentration of hydroxysafflor yellow A being 4.09-30.71 μg·mL⁻¹, the concentration of paeoniflorin being 50.67-380.0 μg·mL⁻¹, ferulic acid concentration being 1.93-14.46 μg·mL⁻¹, calycosin-7-glucoside concentration being 0.38-9.38 μg·mL⁻¹, rosmarinic acid concentration being 4.31-43.07 μg·mL⁻¹, salvianolic acid B being 4.71-47.14 μg·mL⁻¹, formononetin being 3.57-35.71 μg·mL⁻¹, and tanshinone IIA being 1.19-8.93 μg·mL⁻¹.

Preferably, in the liquid chromatography conditions of the described step (3), the column is: ACQUITY UPLC BEH.

Preferably, in the liquid chromatography conditions of the described step (3), the detection flow rate is 0.2 mL-min⁻¹, said detection wavelength is 254 nm, and the detection column temperature is 35° C.

Preferably, in the fingerprint spectrum generated by the detection method, the fingerprint spectrum of the test solution shows chromatographic peaks with the same retention time as the chromatographic peaks of the standard solution, and the similarity evaluation value of Chinese medicine between the fingerprint spectrum of the test solution and the standard solution should not be less than 0.90.

Preferably, in the fingerprint spectrum generated by the method comprise 11 peaks including peak 1: mulberroside A, peak 2: hydroxysafflor yellow A, peak 4: paeoniflorin, peak 5: ferulic acid, peak 6: calycosin-7-glucoside, peak 7: rosmarinic acid, peak 8: salvianolic acid B, peak 10, formononetin, peak 11: tanshinone IIA.

The composition and dosage ratio of the medicinal formulation described in the present invention are: 66 parts of astragalus, 27 parts of red peony root, 27 parts of Salvia miltiorrhiza, 27 parts of Chinese angelica, 27 parts of rhizome of chuanxiong, 27 parts of peach kernel, 13 parts of safflower, 13 parts of frankincense, 13 parts of myrrh, 20 parts of spatholobus stem, 27 parts of achyranthes root, 20 parts of cinnamon twig, 27 parts of mulberry twig, 27 parts of pheretima, 13 parts of scorpion and 27 parts of leech.

The preparation of the formulation described in this invention comprises, pheretima and scorpion are milled into fine powder, and the other 14 ingredients including astragalus, red peony root, Salvia miltiorrhiza, Chinese angelica, rhizome of chuanxiong, peach kernel, safflower, frankincense, myrrh, spatholobus stem, achyranthes root, cinnamon twig, mulberry twig and leech are crushed into fine powder, and mix the two fine powder and then sieve, encapsulate into capsules.

To highlight the innovativeness of the determination method of the pharmaceutical formulation of the present invention, the part of the experiments screened in this experiment are provided below.

1. Index Determination and Method Selection

At present, the main active ingredients in the pharmaceutical formulation of this invention are mostly detected by high performance liquid chromatography (HPLC), but no research focusing on the quality control of multi-wavelength fingerprint spectroscopy has been reported. The pharmaceutical formulation of this invention contains a wide range of compounds. The main components of each single herb have strong UV absorption at 210-405 nm. It is clear that single wavelength measurement method cannot accurately characterize the quantity and concentration of the main ingredients in the pharmaceutical formulation of the present invention. Therefore, by the systematic fingerprint quantification method, the major wavelengths 230, 254, 280, 324 and 400 nm are selected from the chromatograms (190-400 nm) determining by the diode array detector (DAD), and a five-wavelength ultra performance liquid phase (UPLC) fingerprint spectrum of the pharmaceutical formulation is established to obtain the maximum information of the complex chemical fingerprints in the formulation. Also, the sensitivity and accuracy were enhanced to ensure a comprehensive evaluation of the quality of this pharmaceutical formulation.

2. Investigation on the Preparation Method of the Test Solution

In order to obtain a comprehensive composition of the active ingredients in the pharmaceutical formulation, the spectral parameter is used to evaluate the spectral quality of the different extraction methods.

(1) Method 1: The contents in 20 capsules of the pharmaceutical formulation of this invention is taken, weighed precisely, finely ground and then 2.0 g of the contents is weighed precisely, placed in a 150 mL flask with 50 mL of 70% methanol, extracted by ultrasonic treatment for 45 min (power 300 W, frequency 40 kHz), shaken well and filtered to obtain a filtrate. The pellet and the filtrate are washed with 30 mL of 70% ethanol in equal volume for three times to obtain a washing solution, and the washing solution is combined into the filtrate and evaporates at 90° C. in a water bath. The pellet is dissolved by 70% ethanol and transfer to a 25 mL volumetric flask, and 70% h ethanol is added to the line marked on the volumetric flask, shaken well and filtered through a 0.22 μm microporous filter membrane to obtain a second filtrate.

(2) Method 2: The contents of 20 capsules of the pharmaceutical formulation of this invention is taken, weighed it precisely, finely ground and then 2.0 g of the contents is weighed precisely, place in a 150 mL flask with 50 mL of 70% methanol, extract by ultrasonic treatment for 45 min (power 300 W, frequency 40 kHz), shake well and filter it through 0.22 μm microporous filter membrane to get a second filtrate.

(3) Method 3: The contents in 20 capsules of the pharmaceutical formulation of this invention is taken, weighed precisely, finely ground and then 2.0 g of the contents is weighed precisely, placed in a 150 mL flask with 50 mL of 70% methanol, extracted by ultrasonic treatment for 45 min (power 300 W, frequency 40 kHz), shaken well and filtered to obtain a filtrate. The pellet and the filter are washed by 30 mL of 70% ethanol in equal volume for three times to obtain a washing solution, and the washing solution is combined into the filtrate and concentrated by centrifugal evaporator (1465 rpm, concentration temperature 35° C.), and the pellet is dissolved by 70% ethanol and transferred to a 25 mL flask, added with 70% ethanol to the line marked on the flask, shaken well, filtered by 0.22 μm microporous filter membrane to obtain a second filtrate.

(4) Method 4: The contents of 20 capsules of the pharmaceutical formulation of this invention is taken, weighed precisely, ground finely, and then 2.0 g of the contents is weighed precisely, placed in a 150 mL flask with 50 mL of 70% methanol, refluxed at 95° C. for 45 min, filtered while it is hot. The pellet and the filter are washed by 30 mL of 70% ethanol in equal volume for three times to obtain a washing solution, and the washing solution is combined into the filtrate and concentrated in a water bath at 90° C. The pellet is dissolved by adding 70% ethanol and transferred to a 25 mL flask, added with 70% ethanol to the line marked on the flask, shaken well, filtered by 0.22 μm microporous filter membrane to obtain a second filtrate.

(5) Method 5: The contents of 20 capsules of the pharmaceutical formulation of this invention is taken, weighed precisely, ground finely, and then 2.0 g of the contents is weighed precisely, placed in a 150 mL flask with 50 mL of 70% methanol, refluxed at 95° C. for 45 min, cooled to room temperature, shaken well, filtered through 0.22 μm microporous membrane to obtain a second filtrate.

(6) Method 6: The contents of 20 capsules of the pharmaceutical formulation of this invention is taken, weighed precisely, ground finely, and then 2.0 g of the contents is weighed precisely, placed in a 150 mL flask with 50 mL of 70% methanol, refluxed at 95° C. for 45 min, filtered while it is hot. The pellet and the filter are washed by 30 mL of 70% ethanol in equal volume for three times to obtain a washing solution, and the washing solution is combined into the filtrate and concentrated by centrifugal evaporator (1465 rpm, concentration temperature 35° C.), and the pellet is dissolved by 70% ethanol and transferred to a 25 mL flask, added with 70% ethanol to the line marked on the flask, shaken well, filtered by 0.22 μm microporous filter membrane to obtain a second filtrate.

Optimization results are shown (Table 1), the UPLC determination of the extracted method by method 3 gave better chromatographic results, so it was used as a condition for sample test.

TABLE 1
Optimization results of extraction condition

| Extraction | N | Σ Rs | r* | Φ | HCRF |
|---|---|---|---|---|---|
| Method 1 | 54.5 | 140.9737 | 1.77E−06 | 1176.481 | 54590161 |
| Method 2 | 51 | 155.1169 | 1.75E−08 | 1080.165 | 51040585 |
| Method 3 | 60.5 | 125.187 | 4.01E−06 | 1324.094 | 60558972 |
| Method 4 | 59.5 | 125.0911 | 3.7E−06 | 1286.725 | 59535625 |
| Method 5 | 54 | 136.8664 | 3.65E−07 | 1143.863 | 54064320 |
| Method 6 | 58.5 | 137.8683 | 4.01E−07 | 1275.586 | 58560656 |

It is found that the column temperature has a great influence on the separation of paeoniflorin, baicalin and salvianolic acid B. Therefore, different temperatures, such as 20, 25, 30 and 35° C., is investigated, and the separation of astragaloside and salvianolic acid B is not good when the column temperature was higher than 25° C., and the peak shape of paeoniflorin is better when the column temperature is 20 and 25° C., and the separation of astragaloside and salvianolic acid B still show good separation when column temperature is 20 and 25° C. However, different instrument still shows retention time shift, therefore, column temperature is set at 25° C.

3. Optimization of Chromatographic Conditions

In order to obtain an optimal parameter settings, column temperature at 25-35° C., flow rate at 0.1-0.4 mL/min and buffer concentration at 0.1-0.2% formic acid, 0.1% acetic acid and 0.05% phosphoric acid are selected.

The results show that the peak separation and the number of plates are better when the buffer system is 0.2% formic acid, the column temperature is 35° C., and the flow rate is 0.2 ml/min. Therefore, this optimized condition is used as a fixed condition for sample determination.

TABLE 2
Optimization of chromatographic conditions

| Optimization conditions | | N | Σ Rs | r* | Φ | HCRF |
|---|---|---|---|---|---|---|
| Buffer | 0.1 % formic | 13 | 123.134 | 0.0028 | 294.951 | 13100517 |
| system | acid | | | | | |
| | 0.2% formic | 13 | 121.426 | 0.0038 | 271.305 | 13127102 |
| | acid | | | | | |
| | 0.05% formic | 12 | 104.236 | 0.0480 | 254.139 | 12297164 |
| | acid | | | | | |
| | 0.1% acetic | 12 | 104.785 | 0.0264 | 256.094 | 12219408 |
| | acid | | | | | |
| | 0.05% | 12 | 124.686 | 0.0080 | 251.655 | 12080066 |
| | phosphoric | | | | | |
| | acid | | | | | |
| Column | 25° C. | 13 | 123.134 | 0.0028 | 294.951 | 13100517 |
| temperature | 30° C. | 13 | 124.169 | 0.0030 | 273.084 | 13119317 |
| | 35° C. | 13 | 125.990 | 0.0037 | 272.748 | 13183360 |
| Flow rate | 0.1 mL/min | 13 | 105.185 | 0.0187 | 265.117 | 13113343 |
| | 0.2 mL/min | 13 | 123.134 | 0.0028 | 294.951 | 13100517 |
| | 0.3 mL/min | 13 | 148.789 | 0.0009 | 263.496 | 13146515 |
| | 0.4 mL/min | 13 | 147.646 | 0.0008 | 260.041 | 13123966 |

The detection method of present invention shows the following beneficial effects.

(1) In the present invention, ultra-high performance liquid chromatography (UPLC) is used to establish a method for the simultaneous detection of quality markers in pharmaceutical formulation that are closely related to drug efficacy. The detection method not only improves the detection efficiency, but also greatly improves the quality and the effectiveness of the pharmaceutical formulation of the present invention. Based on the results of the present invention on “Q-markers in pharmaceutical formulation of this invention”, a method is established to determine nine quality markers including mulberroside A, hydroxysafflor yellow A, paeoniflorin, ferulic acid, calycosin-7-glucoside, rosmarinic acid, salvianolic acid B, formononetin, and tanshinone IIA. The method is accurate and specific, and can be used for the quality control of the pharmaceutical formulation of this invention.

(2) The fingerprint spectrum established by the method described in the present invention could effectively characterize the quality of the pharmaceutical formulation of the present invention based on the fingerprint quantification method. The method established the ultra-high performance liquid phase (UPLC) fingerprint spectrum of the pharmaceutical formulation of the present invention at five wavelengths is established by the method, including 230, 254, 280, 324 and 400 nm, and the qualitative and quantitative fingerprints information of the pharmaceutical formulation is obtained. This method controls the quality of the efficacy in the pharmaceutical formulation of the present invention and enhances the quality evaluation process of the pharmaceutical formulation.

(3) According to the detection method of the present invention, the results of the measurement precision show that the relative standard deviation (RSD) of retention time of mulberroside A, hydroxysafflor yellow A, paeoniflorin, ferulic acid, calycosin-7-glucoside, rosmarinic acid, salvianolic acid B, formononetin, and tanshinone IIA are in the range of 0.03˜0.21%, and RSD of the peak area are in the range of 0.77/˜1.52%, indicating that the method showed good precision.

The results of repeatability test show that RSD of retention time of the nine components, mulberroside A, hydroxysafflor yellow A, paeoniflorin, ferulic acid, calycosin-7-glucoside, rosmarinic acid, salvianolic acid B, formononetin, and tanshinone IIA, are in the range of 0.02˜0.30%, and RSD of the peak area are in the range of 0.90%˜1.63%, also indicating that the method show well repeatability.

The results of the stability test show that RSD of the retention time RSDs of the nine components of mulberroside A, hydroxysafflor yellow A, paeoniflorin, ferulic acid, calycosin-7-glucoside, rosmarinic acid, salvianolic acid B, formononetin, and tanshinone IIA are in the range of 0.05˜0.85%, and RSD of the peak area are in the range of 1.51%˜1.86%, indicating that the test solution is stable within 48 h at room temperature.

The results of the recovery rate show that RSD of the peak area RSDs of the nine components of mulberroside A, hydroxysafflor yellow A, paeoniflorin, ferulic acid, calycosin-7-glucoside, rosmarinic acid, salvianolic acid B, formononetin, and tanshinone IIA are in the range of 0.26% to 3.24%, which indicate that the recoveries of individual compounds are poor and the method still need to be improved. However, it is found that the content of tanshinone IIA in the formulation is not stable, and further studies is needed. Therefore, tanshinone IIA is not included in the detection method of the present invention.

In summary, the detection method described in the present invention shows precision, stability and repeatability. Therefore, the method for the detection of pharmaceutical formulation of the invention is comprehensive, highly-efficient and accurate, and suitable for quality control when applying mass production.

### DRAWING OF THE PRESENT INVENTION

The drawings illustrated herein are for the purpose of providing a further understanding of the invention and forming part of the invention. The illustrative embodiments of the invention and their descriptions are for the purpose of explaining the invention and do not constitute an undue limitation of the invention. The materials described herein are a pharmaceutical capsule of the present invention.

FIG. 1. Standard fingerprint pattern of the pharmaceutical formulation of the invention contains 11 peaks in the spectrum: peak 1: mulberroside A, peak 2: hydroxysafflor yellow A, peak 4: paeoniflorin, peak 5: ferulic acid, peak 6: calycosin-7-glucoside, peak 7: rosmarinic acid, peak 8: salvianolic acid B, peak 10; formononetin, peak 11: tanshinone IIA.

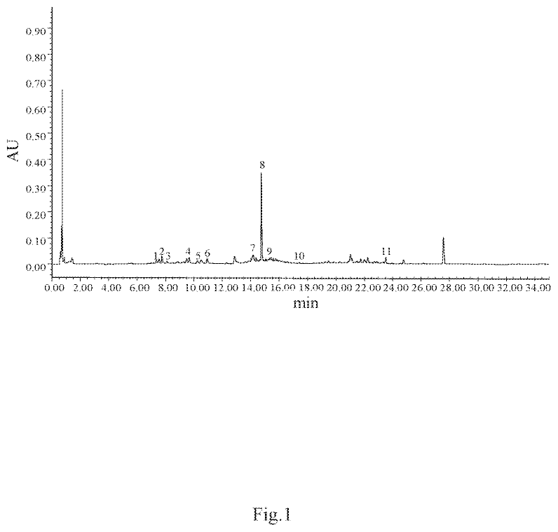

FIG. 2. UPLC control standard spectra of the pharmaceutical formulation of the present invention.

FIG. 3. UPLC spectra of Q-markers control (quality standards), the sample of the pharmaceutical formulation, a mixed sample and negative control samples.

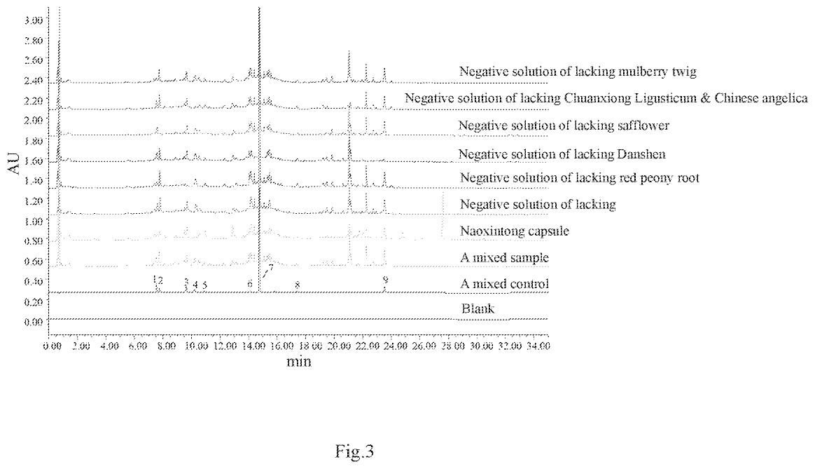

### EMBODIMENTS

In order to understand more fully the implementation of the present invention, the invention is further described below by typical embodiments. Unless otherwise defined, the technical terms or scientific terms used in the specification of the patent application and the claims of the present invention shall have the ordinary meaning as understood by a person having ordinary skill in the art of the invention.

### Example 1: A Fingerprint Detection Method for the Present Pharmaceutical Formulation

1 Apparatus and Reagent

ACQUITY H-CLASS ultra-high performance liquid chromatography system (Waters Corporation, USA), including binary ultra-high pressure solvent system, FTN automatic sampling, PDA detector and Empower 3 chromatography workstation. Sartorius CPA225D 1-in-100,000 electronic balance (Sartorius Scientific Instruments Co., Ltd., Germany). KQ-300DE digital ultrasonic cleaner (Kunshan Ultrasonic Instruments Co., Ltd.).

Calycosin-7-glucoside (Lot No. 111920-201505, Purity: 97.1%) was purchased from the China Academy of Food and Drug Research (CAFRDR), mulberroside A (Lot No. MUST-17060301, Purity: 99.42%), hydroxysafflor yellow A (Lot No. MUST-16092910, Purity: 99.88% HPLC), amygdalin (Lot No. MUST-17042810, purity: 99.28% HPLC), paeoniflorin (lot: MUST-17031901, purity: 99.30%), rosmarinic acid (lot: MUST-17040532, purity: 99.40% HPLC), salvianolic acid B (lot: MUST-17040503, purity: 98.51%), calycosin (batch number: MUST-16120911, purity: 99.84% HPLC), tanshinone IIA (batch number: MUST-17022502, purity: 99.64% HPLC) and formononetin (batch number: MUST-17031005, purity: 99.03% HPLC) were purchased from Chengdu Manstead Biotechnology Co. Ltd. Ferulic acid (lot no.: wkq17022303, purity >98% HPLC) was purchased from Sichuan Vicky Biotechnology Co. Ltd. Acetonitrile (chromatographic purity, Honeywell, Korea), formic acid (chromatographic purity, Fluka), and other reagents were all analytical grade. Water used for the experiments was Watson's distilled water. The pharmaceutical formulation (0.4 g/capsule) was provided by Shaanxi Buchang Pharmaceutical Co., Ltd. and the formulation was certified by Senior Engineer Liu Shijun of Shaanxi Chinese Medicine Resources Industrialization Collaboration and Innovation Center met the requirement of 2015 edition of the Chinese Pharmacopoeia.

2 Methods and Results

2.1 Chromatographic Conditions

An ACQUITY UPLC® BEH C18 (50 mm×2.1 mm, 1.7 μm) column was used. The mobile phase was 0.2% formic acid-water solution (A)-acetonitrile solution (B), and the gradient elution program was 0˜2 min, 2% B: 2˜7 min, 2%-14% B: 7˜9 min, 14%-15% B: 9˜11 min, 15%-16% B: 11˜14 min, 16%-35% B: 14˜16 min, 35% B: 16˜21 min, 35%-70% B: 21˜23 min, 70% B: 23˜28 min, 70%-100% B: 28˜30 min, 100% B: 30˜32 min, 100%-2% B: post-run 5 min. The flow rate was 0.2 ml/min, column temperature was 35° C.; detection wavelength was 254 nm; sample volume was 5 μl.

2.2 Preparation of Standard Solution and Test Solution

2.2.1 Preparation of the Mixed Standard Solution

Amygdalin, mulberroside A, hydroxysafflor yellow A, paeoniflorin, ferulic acid, calycosin-7-glucoside, calycosin, rosmarinic acid, salvianolic acid B, formononetin and tanshinone IIA were accurately weighed, added to methanol to dissolve, diluted to the line marked on the volumetric flask, shaken well, and filtered through a 0.22 μm filter membrane to obtain the mixed standard solution. (Each 1 mL containing 45.8 μg of amygdalin, 68.0 μg of mulberroside A, 83.0 μg of hydroxysafllor yellow A, 350.0 μg of paeoniflorin, 30.0 μg of ferulic acid, 5.0 μg of calycosin-7-glucoside, 6.79 μg of calycosin, 115 μg of rosmarinic acid, 405 μg of salvianolic acid B, 4 μg of formononetin and 36 μg of tanshinone IIA).

2.2.2 Preparation of the Test Solution

The contents in 20 capsules of the pharmaceutical formulation of this invention was taken, weighed precisely, finely ground and then 2.0 g of the contents was weighed precisely, placed in a 150 mL flask with 50 mL of 70% methanol, extracted by ultrasonic treatment for 45 min (power 300 W, frequency 40 kHz), shaken well and filtered to obtain a filtrate. The pellet and the filter were washed by 30 mL of 70% ethanol in equal volume for three times to obtain a washing solution, and the washing solution was combined into the filtrate and concentrated by centrifugal evaporator (1465 rpm, concentration temperature 35° C.), and the pellet was dissolved by 70% ethanol and transferred to a 25 mL flask, added with 70% ethanol to the line marked on the flask, shaken well, filtered by 0.22 μm microporous filter membrane to obtain the test solution.

2.3 Methodological Verification

2.3.1 Systemic Suitability

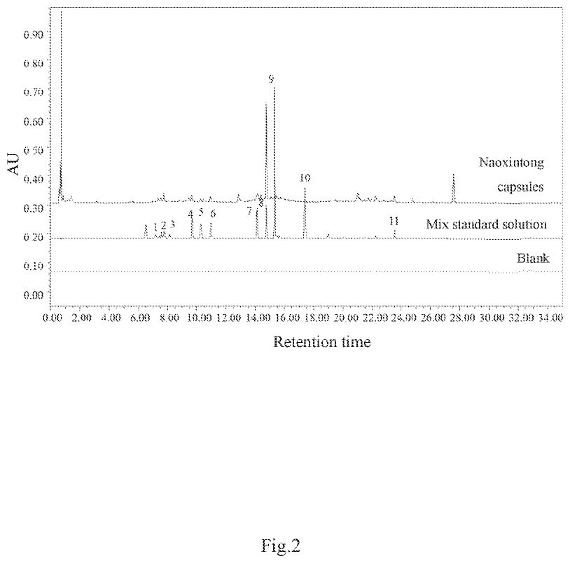

The test solution and the mixed standard solution were sampled separately according to the liquid phase conditions under above section 2.1, and six-wavelength UPLC spectra were recorded (FIG. 2). The testing method of Naoxintong capsules was referenced by the Chinese Pharmacopoeia 2015 edition, and 21 peaks were identified with the reference peaks of amygdalin, mulberroside A, hydroxysafflor yellow A, paeoniflorin, ferulic acid, calycosin-7-glucoside, calycosin, rosmarinic acid, salvianolic acid B, formononetin and tanshinone IIA. The theoretical plate at 254 nm was determined to be not less than 20,000. A blank sample was fed with the same volume and run for 35 min, proving that there was no interference peak (see FIG. 2).

2.3.2 Precision Test

The mixed standard solution as described in section 2.2.1 was taken carefully and measured 6 times continuously according to the chromatographic conditions of section 2.1, and the peak area was recorded. The results showed that the RSD of retention time of the 11 components were 0.03˜0.21% and the RSD of peak area were 0.77/˜1.57%, indicating that the method showed good precision (Table 4).

TABLE 4
Instrument precision results

| | Average | Retention | Average | Peak area |
|---|---|---|---|---|
| Compounds | retention time | time RSD % | peak area | RSD % |
| mulberroside A | 7.578 | 0.18 | 56225.37 | 1.42 |
| hydroxysafflor | 7.775 | 0.18 | 62735.21 | 1.28 |
| yellow A | | | | |
| amygdalin | 8.129 | 0.18 | 36568.13 | 1.57 |
| paeoniflorin | 9.672 | 0.17 | 134092.5 | 1.51 |
| ferulic acid | 10.270 | 0.17 | 131481.1 | 1.21 |
| calycosin-7- | 10.947 | 0.21 | 120503.3 | 1.52 |
| glucoside | | | | |
| rosmarinic acid | 14.123 | 0.06 | 159664.4 | 1.30 |
| salvianolic | 14.749 | 0.03 | 145783.8 | 1.26 |
| acid B | | | | |
| calycosin | 15.311 | 0.03 | 732900.9 | 1.28 |
| formononetin | 17.391 | 0.04 | 408082.0 | 1.22 |
| tanshinone IIA | 23.542 | 0.04 | 62217.1 | 0.77 |

2.3.3 Repeatability Test

Six test solutions, labeled 1 to 6, were prepared according to the test preparation method under section 2.2.2, and each test solution was precisely taken and sampled and determined according to the chromatographic conditions under section 2.1. The peak areas were recorded and the quality scores were calculated. The results showed that the RSD of retention time of the 11 components was 0.02˜0.30%, and the RSD of peak area was 0.89%˜1.63%, which indicated that the method showed good repeatability (Table 5).

TABLE 5
Repeatability test results

| | Average | Retention | Average | Peak area |
|---|---|---|---|---|
| Compounds | retention time | time RSD % | peak area | RSD % |
| mulberroside A | 7.56 | 0.29 | 174253.30 | 0.90 |
| hydroxysafflor | 7.75 | 0.30 | 231495.20 | 1.07 |
| yellow A | | | | |
| amygdalin | 8.11 | 0.28 | 49222.19 | 1.48 |
| paeoniflorin | 9.64 | 0.24 | 205683.30 | 1.60 |
| ferulic acid | 10.25 | 0.24 | 128608.30 | 1.28 |
| calycosin-7- | 10.91 | 0.28 | 168400.50 | 1.49 |
| glucoside | | | | |
| rosmarinic acid | 14.16 | 0.07 | 473330.00 | 0.90 |
| salvianolic | 14.73 | 0.05 | 2124189.00 | 1.63 |
| acid B | | | | |
| calycosin | 15.30 | 0.04 | 119091.80 | 1.24 |
| formononetin | 17.38 | 0.06 | 38220.98 | 1.41 |
| tanshinone IIA | 23.53 | 0.02 | 237458.10 | 1.55 |

2.3.4 Stability Test

An appropriate amount of the test solution as described in section 2.2.2 was placed at room temperature for 0, 3, 6, 12, 18, 24, 36, 48 h. They were measured according to the chromatographic conditions under section 2.1 and the peak areas were recorded. The results showed that the RSD of retention time of the 11 components ranged from 0.05 to 0.82%, and the RSD of peak area ranged from 1.51% to 1.86%, indicating that the test solution was stable within 48 h at room temperature (Table 6).

TABLE 6
Stability test results

| | Average | Retention | Average | Peak area |
|---|---|---|---|---|
| Compounds | retention time | time RSD % | peak area | RSD % |
| mulberroside A | 7.71 | 0.82 | 55518.80 | 1.61 |
| hydroxysafflor | 7.92 | 0.85 | 62549.39 | 1.55 |
| yellow A | | | | |
| amygdalin | 8.25 | 0.80 | 35715.85 | 1.86 |
| paeoniflorin | 9.77 | 0.62 | 133892.50 | 1.66 |
| ferulic acid | 10.47 | 0.73 | 127651.40 | 1.82 |
| calycosin-7- | 11.06 | 0.61 | 122442.80 | 1.51 |
| glucoside | | | | |
| rosmarinic acid | 14.20 | 0.22 | 156851.40 | 1.74 |
| salvianolic | 14.79 | 0.13 | 145843.30 | 1.86 |
| acid B | | | | |
| calycosin | 15.35 | 0.12 | 713737.00 | 1.61 |
| formononetin | 17.43 | 0.15 | 396847.50 | 1.68 |
| tanshinone IIA | 23.55 | 0.05 | 60705.73 | 1.69 |

2.3.5 Systematic Fingerprint Quantification Method

Due to the complexity of Chinese medicine components, it is relatively one-sided to measure the quality of traditional Chinese medicine by the content of one or more components. Based on the macro-qualitative Sm and macro-quantitative Pm index of chromatographic fingerprints described by Prof. Guo-Xiang Sun, systematic fingerprint quantification method was used to conduct macro-analysis of fingerprint profiles of Chinese medicine and obtain the overall quantitative and qualitative analysis of Chinese medicine.

The macro-qualitative similarity are used to evaluate the number and distribution ratio of fingerprints in the spectrum, avoiding the “masking” effect of main component peaks on small peaks and the “desensitization” of main component shifts. The macro-qualitative similarity could reflect the similarity and content changes of the Chinese medicine and the control components at the same time. By evaluating the overall quality of medicine and intermediates, the accuracy and reliability of the systematic fingerprint analysis method were demonstrated.

The quality of 15 batches of the present formulation was analyzed based on the quantitative systematic fingerprinting method. The number of fingerprints and the distribution ratio of fingerprints in the fingerprint spectra were monitored by macro-qualitative similarity Sm (Formula 1), the number of peaks and peak heights in the fingerprint spectra were calculated quantitatively by macro-qualitative similarity Pm (Formula 2), and the variability of the peaks in the fingerprint spectra was calculated by the absolute value of the coefficient of variation of fingerprint homogenization a (Formula 3). The results of the three calculations were combined to determine the quality of the formulation and intermediates, and the accuracy and reliability of systematic fingerprinting were demonstrated.

$$( Formula 1 )$$

$${S}_{m} = \frac{1}{2} ( {S}_{F} + {S}_{F}^{′} ) = \frac{1}{2 ( \frac{{\sum }_{i = 1}^{n} {x}_{i} {y}_{i}}{\sqrt{{\sum }_{i = 1}^{n} {x}_{i}^{2}} \sqrt{{\sum }_{i = 1}^{n} {y}_{i}^{2}}} + \frac{{\sum }_{i = 1}^{n} \frac{{x}_{i}}{{y}_{i}}}{\sqrt{n {\sum }_{i = 1}^{n} {( \frac{{x}_{i}}{{y}_{i}} )}^{2}}}}$$

$${P}_{m} = \frac{1}{2} ( C + P ) = ( \frac{{\sum }_{i = 1}^{n} {x}_{i} {y}_{i}}{{\sum }_{i = 1}^{n} {y}_{i}^{2}} + \frac{{\sum }_{i = 1}^{n} {x}_{i}}{{\sum }_{i = 1}^{n} {y}_{i}} {S}_{F} ) \times 100 \% \qquad ( Formula 2 )$$

$$α = \vert 1 \vert \frac{{γ}_{x}}{{γ}_{y}} \vert = \vert 1 \vert \frac{P}{C} \vert \qquad ( Formula 3 )$$

Note: SF is qualitative similarity, SF′ is ratio qualitative similarity, Sm is macro-qualitative similarity, P is quantitative similarity, C is projection content similarity, Pm is macro-quantitative similarity, xi (x1, x2, . . . xn) is sample fingerprint vector (peak area), yi (x1, x2, . . . xn) is the generated control fingerprint vector (peak area)
The quality of the formulation at each wavelength was identified by the systematic fingerprint quantification method by the three indicators of macro-quantitative similarity Sm, macro-quantitative similarity Pm and coefficient of variation α according to the Chinese medicine quality identification standard (8 levels) (Table 7).

TABLE 7
Quality identification standards for
Chinese medicines at eight levels

| Level | Sm> | Pm %> | α< | Results |
|---|---|---|---|---|
| 1 | 0.95 | 95~105 | 0.05 | Excellent |
| 2 | 0.90 | 90~110 | 0.10 | Very good |
| 3 | 0.85 | 80~120 | 0.15 | Good |
| 4 | 0.80 | 75~125 | 0.20 | Average |
| 5 | 0.70 | 70~130 | 0.30 | Fair |
| 6 | 0.60 | 60~140 | 0.40 | Acceptable |
| 7 | 0.50 | 50~150 | 0.50 | Poor |
| 8 | <0.50 | 0-∞ | >0.50 | Extreme poor |

The classification results (see Table 7) showed that the quantity, distribution ratio and fingerprint ratio of the fifteen batches of the formulation tested at six wavelengths were similar. The results showed that the detection quality was poorer at 300 nm, indicating that identification under single wavelength was poor. Therefore, five wavelengths, 230, 254, 280, 324 nm and 400 nm were used for the quality evaluation.

TABLE 8
Results of the quantitative fingerprinting of the pharmaceutical formulation by six
wavelengths

| 230 nm | Sm | Pm | a | Result | 254 nm | Sm | Pm | a | Result |
|---|---|---|---|---|---|---|---|---|---|
| 17030101 | 0.966 | 1.294 | 0.029 | Very | 17030101 | 0.984 | 1.425 | 0.006 | Good |
| | | | | good | | | | | |
| 17040101 | 0.941 | 1.531 | 0.042 | Very | 17040101 | 0.943 | 1.196 | 0.092 | Very |
| | | | | good | | | | | good |
| 17050101 | 0.976 | 1.315 | 0.038 | Very | 17050101 | 0.980 | 1.366 | 0.025 | Very |
| | | | | good | | | | | good |
| 17060101 | 0.963 | 1.358 | 0.028 | Very | 17060101 | 0.974 | 1.446 | 0.011 | Very |
| | | | | good | | | | | good |
| 1801145 | 0.947 | 1.176 | 0.054 | Very | 1801145 | 0.960 | 1.199 | 0.097 | Very |
| | | | | good | | | | | good |
| 1801146 | 0.973 | 1.261 | 0.035 | Very | 1801146 | 0.979 | 1.301 | 0.008 | Very |
| | | | | good | | | | | good |
| 1801147 | 0.968 | 1.283 | 0.008 | Very | 1801147 | 0.976 | 1.368 | 0.086 | Very |
| | | | | good | | | | | good |
| 1801207 | 0.947 | 1.269 | 0.002 | Very | 1801207 | 0.951 | 1.188 | 0.007 | Excellent |
| | | | | good | | | | | |
| 1801208 | 0.958 | 1.180 | 0.020 | Excellent | 1801208 | 0.956 | 1.302 | 0.070 | Very |
| | | | | | | | | | good |
| 1801215 | 0.969 | 1.143 | 0.008 | Excellent | 1801215 | 0.950 | 1.039 | 0.046 | Excellent |
| 1801216 | 0.965 | 1.069 | 0.021 | Excellent | 1801216 | 0.943 | 1.067 | 0.028 | Excellent |
| 1801217 | 0.969 | 1.104 | 0.020 | Excellent | 1801217 | 0.967 | 1.020 | 0.047 | Excellent |
| 1801218 | 0.974 | 1.069 | 0.023 | Excellent | 1801218 | 0.945 | 1.078 | 0.027 | Excellent |
| 1801219 | 0.971 | 1.121 | 0.008 | Excellent | 1801219 | 0.976 | 1.030 | 0.052 | Excellent |
| 280 nm | Sm | Pm | a | Result | 300 nm | Sm | Pm | a | Result |
| 17030101 | 0.977 | 1.381 | 0.016 | Very | 17030101 | 0.942 | 1.589 | 0.046 | Good |
| | | | | good | | | | | |
| 17040101 | 0.972 | 1.378 | 0.005 | Very | 17040101 | 0.986 | 1.442 | 0.014 | Good |
| | | | | good | | | | | |
| 17050101 | 0.982 | 1.364 | 0.017 | Very | 17050101 | 0.990 | 1.475 | 0.013 | Good |
| | | | | good | | | | | |
| 17060101 | 0.977 | 1.410 | 0.029 | Very | 17060101 | 0.986 | 1.469 | 0.035 | Good |
| | | | | good | | | | | |
| 1801145 | 0.968 | 1.357 | 0.008 | Very | 1801145 | 0.982 | 1.458 | 0.019 | Good |
| | | | | good | | | | | |
| 1801146 | 0.974 | 1.353 | 0.017 | Very | 1801146 | 0.970 | 1.441 | 0.046 | Good |
| | | | | good | | | | | |
| 1801147 | 0.969 | 1.294 | 0.035 | Very | 1801147 | 0.649 | 0.016 | 0.364 | Acceptable |
| | | | | good | | | | | |
| 1801207 | 0.938 | 1.274 | 0.018 | Very | 1801207 | 0.667 | 0.021 | 0.318 | acceptable |
| | | | | good | | | | | |
| 1801208 | 0.937 | 1.028 | 0.110 | Very | 1801208 | 0.959 | 1.209 | 0.005 | Very |
| | | | | good | | | | | good |
| 1801215 | 0.960 | 1.114 | 0.041 | Excellent | 1801215 | 0.663 | 0.019 | 0.311 | Acceptable |
| 1801216 | 0.941 | 0.943 | 0.053 | Very | 1801216 | 0.941 | 0.943 | 0.053 | Very |
| | | | | good | | | | | good |
| 1801217 | 0.943 | 1.009 | 0.042 | Excellent | 1801217 | 0.974 | 1.196 | 0.022 | Excellent |
| 1801218 | 0.935 | 0.945 | 0.062 | Very | 1801218 | 0.967 | 1.127 | 0.006 | Excellent |
| | | | | good | | | | | |
| 1801219 | 0.938 | 0.973 | 0.067 | Excellent | 1801219 | 0.963 | 1.159 | 0.010 | Excellent |
| 324 nm | Sm | Pm | a | Result | 400 nm | Sm | Pm | a | Result |
| 17030101 | 0.974 | 1.361 | 0.027 | Very | 17030101 | 0.975 | 1.533 | 0.028 | Good |
| | | | | good | | | | | |
| 17040101 | 0.974 | 1.346 | 0.043 | Very | 17040101 | 0.974 | 1.476 | 0.075 | Good |
| | | | | good | | | | | |
| 17050101 | 0.982 | 1.345 | 0.026 | Very | 17050101 | 0.976 | 1.521 | 0.031 | Good |
| | | | | good | | | | | |
| 17060101 | 0.981 | 1.369 | 0.028 | Very | 17060101 | 0.983 | 1.476 | 0.063 | Good |
| | | | | good | | | | | |
| 1801145 | 0.969 | 1.316 | 0.024 | Very | 1801145 | 0.973 | 1.480 | 0.081 | Good |
| | | | | good | | | | | |
| 1801146 | 0.969 | 1.266 | 0.062 | Very | 1801146 | 0.972 | 1.451 | 0.065 | Good |
| | | | | good | | | | | |
| 1801147 | 0.970 | 1.256 | 0.024 | Very | 1801147 | 0.947 | 1.009 | 0.106 | Very |
| | | | | good | | | | | good |
| 1801207 | 0.959 | 1.248 | 0.049 | Very | 1801207 | 0.964 | 1.069 | 0.142 | Very |
| | | | | good | | | | | good |
| 1801208 | 0.962 | 1.176 | 0.028 | Excellent | 1801208 | 0.867 | 0.611 | 0.057 | Good |
| 1801215 | 0.959 | 1.144 | 0.061 | Excellent | 1801215 | 0.970 | 1.169 | 0.130 | Very |
| | | | | | | | | | good |
| 1801216 | 0.960 | 1.086 | 0.055 | Very | 1801216 | 0.980 | 1.076 | 0.070 | Very |
| | | | | good | | | | | good |
| 1801217 | 0.949 | 1.247 | 0.168 | Good | 1801217 | 0.938 | 1.195 | 0.176 | Very |
| | | | | | | | | | good |
| 1801218 | 0.955 | 1.100 | 0.066 | Very | 1801218 | 0.725 | 1.106 | 0.113 | Good |
| | | | | good | | | | | |
| 1801219 | 0.958 | 1.125 | 0.056 | Excellent | 1801219 | 0.947 | 1.152 | 0.120 | Very |
| | | | | | | | | | good |

### Example 2: Content Determination of the Pharmaceutical Formulation of this Invention

2.1 Assay

2.1.1 Chromatographic Conditions

An ACQUITY UPLC® BEH C18 (50 mm×2.1 mm, 1.7 μm) column was used with a mobile phase of 0.2% formic acid—aqueous solution (A)—acetonitrile solution (B) and a gradient elution procedure of 0˜2 min, 2% B: 2-7 min; 2%-14% B: 7˜9 min; 14%-15% B: 9˜11 min; 15%-16% B: 11˜14 min; 16%-35% B: 14˜16 min; 35% B: 16-21 min; 35%-70% B: 21˜23 min; 70% B: 23-28 min; 70%-100% B: 28-30 min; 100% B: 30-32 min; 100%-2% B: post-run 5 min. Flow rate 0.2 ml/min, column temperature 35° C., detection wavelength 254 nm, injection volume 5 μl.

2.1.2 Preparation of the Mixed Standard Solution

Mulberroside A, hydroxysafflor yellow A, paeoniflorin, ferulic acid, calycosin-7-glucoside, rosmarinic acid, salvianolic acid B, formononetin and tanshinone IIA were accurately weighed, added to methanol to dissolve, diluted to the line marked on the volumetric flask, shaken well, and filtered through a 0.22 μm filter membrane to obtain the mixed standard solution. (Each 1 mL containing 68 μg of mulberroside A, 83 μg of hydroxysafflor yellow A, 350 μg of paeoniflorin, 30 μg of ferulic acid, 5 μg of calycosin, 115 μg of rosmarinic acid, 405 μg of salvianolic acid B, 4 μg of formononetin and 36 μg of tanshinone IIA).

2.1.3 Preparation of the Test Solution

The contents in 20 capsules of the pharmaceutical formulation of this invention was taken, weighed precisely, finely ground and then 2.0 g of the contents was weighed precisely, placed in a 150 mL flask with 50 mL of 70% methanol, extracted by ultrasonic treatment for 45 min (power 300 W, frequency 40 kHz), shaken well and filtered to obtain a filtrate. The pellet and the filter were washed by 30 mL of 70% ethanol in equal volume for three times to obtain a washing solution, and the washing solution was combined into the filtrate and concentrated by centrifugal evaporator (1465 rpm, concentration temperature 35° C.), and the pellet was dissolved by 70% ethanol and transferred to a 25 mL flask, added with 70% ethanol to the line marked on the flask, shaken well, filtered by 0.22 μm microporous filter membrane to obtain the test solution.

2.2 Methodological Validation

2.2.1 Linearity, Detection Limit and Quantification Limit

The mixed standard solutions of the nine Q-markers were taken precisely and optimized analytical conditions according to section 2.1.1, wherein the peak area as Y-axis and the concentration of the standard solutions (X, μg/ml) as X-axis. The linearity of the nine standard compounds ranged from 0.38 to 380.00 μg/mL, and the linearity was good.

The limits of detection (LOD) were calculated according to S/N>3 and the limits of quantification (LOQ) were calculated according to S/N>10 by using a negative sample and adding different concentrations of the standard control solution. The LOD of the present method was 0.06-3.79 μg/mL, and the LOQ was 0.19˜5.05 μg/mL. The linear equations, correlation coefficients, limits of detection and limits of quantification of the nine Q-markers were shown in Table 9.

TABLE 9
Linear equations, linear range, r, LOD and LOQ
of the nine Q-markers of Naoxintong capsules

| | Retention | | linear ranges/ | LOD/ | LOQ/ |
|---|---|---|---|---|---|
| Compounds | time/min | Linear equations/r | (μg/mL) | (μg/mL) | (μg/mL) |
| mulberroside A | 7.609 | y = 1543.2x − 4622.9, | 5.05-37.86 | 3.79 | 5.05 |
| | | r = 0.9996 | | | |
| hydroxysafflor | 7.822 | y = 2276.9x − 5151.2, | 4.09-30.71 | 0.61 | 4.09 |
| yellow A | | r = 0.9996 | | | |
| paeoniflorin | 9.532 | y = 381.92x − 8552.6, | 50.67-380.00 | 1.90 | 7.60 |
| | | r = 0.9996 | | | |
| ferulic acid | 10.332 | y = 8426.5x − 13935, | 1.93-14.46 | 0.29 | 1.93 |
| | | r = 0.9995 | | | |
| calycosin-7- | 10.761 | y = 4800.8x + 248.63, | 0.38-9.38 | 0.06 | 0.19 |
| glucoside | | r = 0.9996 | | | |
| rosmarinic acid | 13.211 | y = 4115.6x − 14667, | 4.31-43.07 | 0.86 | 4.31 |
| | | r = 0.9997 | | | |
| salvianolic | 13.867 | y = 3343.4x − 14380, | 4.71-47.14 | 0.63 | 4.71 |
| acid B | | r = 0.9997 | | | |
| formononetin | 17.105 | y = 12241x − 35194, | 3.57-35.71 | 0.09 | 0.48 |
| | | r = 0.9997 | | | |
| tanshinone IIA | 23.739 | y = 6730.6x − 4256.1, | 1.19-8.93 | 0.18 | 1.19 |
| | | r = 0.9998 | | | |

2.2.2 Specificity Test

According to the method under section 2.1.3, a negative sample solution of lacking astragalus, a negative sample solution of lacking Salvia miltiorrhiza, a negative sample solution of lacking red peony root, a negative sample solution of Safflower, a negative sample solution of lacking rhizome of chuanxiong and Chinese angelica, and a negative sample solution of lacking mulberry twig were prepared, respectively. The blank solution, the mixed standard solution, the test solution and the negative sample solutions were sucked precisely and measured according to the chromatographic conditions under section 2.1. Through analysis, the nine active ingredients did not interfere with each other, and the theoretical plate was met with the requirements. As shown in FIG. 2 in the specification, the absence of astragalus solution showed no chromatographic peaks of calycosin-7-glucoside and salvianolic acid B. The absence of Salvia miltiorrhiza solution showed no peaks of tanshinone IIA, salvianolic acid B and rosmarinic acid. The absence of red peony root solution showed no peaks of paeoniflorin at the corresponding positions. The absence of safflower negative solution showed no peaks of hydroxysafflor yellow A. The absence of rhizome of chuanxiong and Chinese angelica solution showed no peaks of ferulic acid. The absence of mulberry twig solution showed no peaks mulberroside A. Therefore, the specificity showed well.

2.2.3 Precision Test

The mixed standard solution as described in section 2.2.1 was taken carefully and measured 6 times continuously according to the chromatographic conditions of section 2.1, and the peak area was recorded. The results showed that the RSD of retention time of the 9 components was 0.03˜0.21% and the RSD of peak area was 0.77%˜1.52%, indicating that the method showed good precision (Table 10).

TABLE 10
Instrument precision results

| | Average | Retention | Average | Peak area |
|---|---|---|---|---|
| Compounds | retention time | time RSD % | peak area | RSD % |
| mulberroside A | 7.58 | 0.18 | 56225.37 | 1.42 |
| hydroxysafflor | 7.78 | 0.18 | 62735.21 | 1.28 |
| yellow A | | | | |
| paeoniflorin | 9.67 | 0.17 | 134092.50 | 1.51 |
| ferulic acid | 10.27 | 0.17 | 131481.10 | 1.21 |
| calycosin-7- | 10.95 | 0.21 | 120503.30 | 1.52 |
| glucoside | | | | |
| rosmarinic acid | 14.12 | 0.06 | 159664.40 | 1.30 |
| salvianolic | 14.75 | 0.03 | 145783.80 | 1.26 |
| acid B | | | | |
| formononetin | 17.39 | 0.04 | 408082.00 | 1.22 |
| tanshinone IIA | 23.54 | 0.04 | 62217.10 | 0.77 |

2.2.4 Repeatability Test

Six test solutions, labeled 1 to 6, were prepared according to the test preparation method under section 2.1.3, and each test solution was precisely taken and sampled and determined according to the chromatographic conditions under section 2.1.1. The peak areas were recorded and the quality scores were calculated. The results showed that the RSD of retention time of the 9 components was 0.02˜0.30%, and the RSD of peak area was 0.90%˜1.63%, which indicated that the method showed good repeatability (Table 11).

TABLE 11
Repeatability test results

| | Average | Retention | Average | Peak area |
|---|---|---|---|---|
| Compounds | retention time | time RSD % | peak area | RSD % |
| mulberroside A | 7.56 | 0.29 | 174253.30 | 0.90 |
| hydroxysafflor | 7.75 | 0.30 | 231495.20 | 1.07 |
| yellow A | | | | |
| paeoniflorin | 9.64 | 0.24 | 205683.30 | 1.60 |
| ferulic acid | 10.25 | 0.24 | 128608.30 | 1.28 |
| calycosin-7- | 10.91 | 0.28 | 168400.50 | 1.49 |
| glucoside | | | | |
| rosmarinic acid | 14.16 | 0.07 | 473330.00 | 0.90 |
| salvianolic | 14.73 | 0.05 | 2124189.00 | 1.63 |
| acid B | | | | |
| formononetin | 17.38 | 0.06 | 38220.98 | 1.41 |
| tanshinone IIA | 23.53 | 0.02 | 237458.10 | 1.55 |

2.2.5 Stability Test

An appropriate amount of the test solution under section 2.1.3 was taken and placed it at room temperature for 0, 3, 6, 12, 18, 24, 36, 48 h. They were measured according to the chromatographic conditions under section 2.1.1 and the peak areas were recorded. The results showed that the RSD of retention time of the 9 components ranged from 0.05 to 0.85%, and the RSD of peak area ranged from 1.51% to 1.86%, indicating that the test solution was stable within 48 h at room temperature (Table 12).

TABLE 12
Stability test results

| | Average | Retention | Average | Peak area |
|---|---|---|---|---|
| Compounds | retention time | time RSD % | peak area | RSD % |
| mulberroside A | 7.71 | 0.82 | 55518.80 | 1.61 |
| hydroxysafflor | 7.92 | 0.85 | 62549.39 | 1.55 |
| yellow A | | | | |
| paeoniflorin | 9.77 | 0.62 | 133892.50 | 1.66 |
| ferulic acid | 10.47 | 0.73 | 127651.40 | 1.82 |
| calycosin-7- | 11.06 | 0.61 | 122442.80 | 1.51 |
| glucoside | | | | |
| rosmarinic acid | 14.20 | 0.22 | 156851.40 | 1.74 |
| salvianolic | 14.79 | 0.13 | 145843.30 | 1.86 |
| acid B | | | | |
| formononetin | 17.43 | 0.15 | 396847.50 | 1.68 |
| tanshinone 11A | 23.55 | 0.05 | 60705.73 | 1.69 |

2.2.6 Recovery Test

One ml of the concentrated extracts of the determined index under section 2.1.3 was taken, a total of 6 parts were taken into a 10 mL flask respectively, and each part contained 1 ml mixed control solution which a certain amount of mulberroside A, hydroxysafflor yellow A, paeoniflorin, ferulic acid, calycosin-7-glucoside, rosmarinic acid, salvianolic acid B, formononetin and tannin IIA was added. They were measured according to the conditions under section 2.1.1, and the peak areas were recorded and the sample recoveries were calculated. The results were shown in Table 13, which indicates that the recoveries of individual compounds were not satisfactory and the method needed to be improved.

TABLE 13
Sampling recovery test results (%, n = 5)

| | 80% | | 100% | | 120% | |
|---|---|---|---|---|---|---|
| | recovery | RSD | recovery | RSD | recovery | RSD |
| Compounds | % | % | % | % | % | % |
| mulberroside A | 109.50 | 2.57 | 107.27 | 0.56 | 105.10 | 0.79 |
| hydroxysafflor yellow A | 112.35 | 0.93 | 108.55 | 0.81 | 108.39 | 0.94 |
| paeoniflorin | 113.37 | 1.98 | 113.38 | 0.26 | 134.93 | 0.94 |
| ferulic acid | 118.23 | 0.74 | 116.77 | 3.24 | 114.11 | 2.39 |
| calycosin-7-glucoside | 128.17 | 1.94 | 124.07 | 2.07 | 124.16 | 1.22 |
| rosmarinic acid | 115.43 | 2.76 | 112.00 | 0.48 | 110.16 | 1.16 |
| salvianolic acid B | 103.44 | 0.87 | 100.89 | 0.71 | 99.16 | 0.79 |
| formononetin | 109.68 | 1.08 | 105.67 | 0.53 | 109.57 | 1.69 |
| tanshinone IIA | 84.17 | 2.47 | 100.51 | 1.29 | 79.87 | 0.86 |

2.2.7 Sample Concentration

15 batches of pharmaceutical formulation samples of the present invention were taken, 3 test solutions were prepared for each batch according to section 2.1.3. Two μl of the standard control solution and 2˜5 μl of the test solution were taken precisely, injected into the liquid chromatograph, measured, the peak areas were recorded, and the concentration of each component in each batch was calculated, see Table 14.

TABLE 14
Average results of sample determination (mg/g, n = 3)

| | mulberroside | hydroxysafflor | | ferulic | calycosin- | rosmarinic | salvianolic | | tanshinone |
|---|---|---|---|---|---|---|---|---|---|
| Lot | A | yellow A | paeoniflorin | acid | 7-glucoside | acid | acid B | formononetin | IIA |
| 17030101 | 0.354 | 0.255 | 2.528 | 0.052 | 0.040 | 0.045 | 2.340 | 0.003 | 1.029 |
| 17040101 | 0.308 | 0.251 | 2.561 | 0.064 | 0.030 | 0.037 | 2.135 | 0.001 | 0.545 |
| 17050101 | 0.443 | 0.245 | 2.408 | 0.060 | 0.027 | 0.029 | 2.189 | 0.003 | 0.693 |
| 17060101 | 0.378 | 0.205 | 2.205 | 0.064 | 0.041 | 0.041 | 2.351 | 0.002 | 0.904 |
| 1801145 | 0.254 | 0.127 | 1.904 | 0.039 | 0.022 | 0.020 | 1.190 | 0.004 | 0.790 |
| 1801146 | 0.386 | 0.190 | 2.761 | 0.065 | 0.035 | 0.034 | 1.878 | 0.005 | 0.801 |
| 1801147 | 0.325 | 0.166 | 2.350 | 0.052 | 0.029 | 0.030 | 1.596 | 0.004 | 0.675 |
| 1801207 | 0.423 | 0.220 | 3.426 | 0.064 | 0.038 | 0.039 | 2.056 | 0.009 | 0.679 |
| 1801208 | 0.417 | 0.207 | 3.245 | 0.064 | 0.039 | 0.038 | 2.034 | 0.008 | 0.927 |
| 1801215 | 0.345 | 0.185 | 2.628 | 0.055 | 0.028 | 0.031 | 1.676 | 0.008 | 0.790 |
| 1801216 | 0.312 | 0.163 | 2.382 | 0.046 | 0.026 | 0.027 | 1.339 | 0.008 | 0.753 |
| 1801217 | 0.341 | 0.183 | 2.591 | 0.054 | 0.028 | 0.029 | 1.650 | 0.008 | 0.794 |
| 1801218 | 0.344 | 0.192 | 2.770 | 0.059 | 0.033 | 0.031 | 1.635 | 0.009 | 0.854 |
| 1801219 | 0.291 | 0.158 | 2.241 | 0.041 | 0.025 | 0.026 | 1.454 | 0.008 | 1.085 |
| 1801220 | 0.340 | 0.184 | 2.438 | 0.057 | 0.032 | 0.037 | 1.759 | 0.007 | 0.659 |

In summary, the concentration of each capsule in the pharmaceutical formulation of this invention contained paeoniflorin (C₂₃H₂₈O₁₁), salvianolic acid B (C₃₆H₃₀O₆), hydroxysafflor yellow A (C₂₇H₃₂O₁₆), mulberroside A (C₂₆H₃₂O₁₄), tanshinone IIA (C₉H₁₈O₃), ferulic acid (C₁₀H₁₀O₄), rosmarinic acid (C₁₈H₁₆O₈), calycosin-7-glucoside (C₂₂H₂₂O₁₀) and formononetin (C₁₆H₁₂O₄), and the concentration of paeoniflorin was not less than 0.6 mg/capsule, salvianolic acid B was not less than 0.9 mg/capsule, hydroxysafflor yellow A was not less than 0.14 mg/capsule, mulberroside A was not less than 7 μg/capsule, tanshinone IIA was not less than 0.045 mg/capsule, ferulic acid was not less than 0.041 mg/capsule, rosmarinic acid was not less than 0.7 mg/capsule, calycosin-7-glucoside was not less than 0.014 mg/capsule, and formononetin was not less than 0.5 mg/capsule.

Finally, it should be noted that the present invention is not limited to the above specific embodiments, which are merely schematic and instructive, and not limiting. Any changes, equivalent substitutions and improvements made by a person of ordinary skill in the art under the inspiration of this specification, but within the spirit and substance of the present invention, are within the scope of protection of the present invention.

1. A fingerprint detection method of a pharmaceutical formulation, characterized in that the steps comprise:
(1) preparation of a test solution: taking and mixing an appropriate amount of the ingredients of the invention, adding 65-75% methanol for extraction, ultrasonic treating, shaking well, filtering to obtain a filtrate and a pellet, the pellet washing with 65-75% ethanol for several times, combining the ethanol washing solution into the filtrate, evaporating the filtrate, the pellet resolving with 65-75% ethanol and diluting to a scale, shaking well, filtering to obtain the test solution;
(2) preparation of a mixed standard solution: precise weighing of paeoniflorin, salvianolic acid B, hydroxysafflor yellow A, mulberroside A, tanshinone IIA, ferulic acid, rosmarinic acid, calycosin-7-glucoside and formononetin in an appropriate amounts to obtain a mixture, adding methanol to solve the mixture to obtain the mixed standard solution;
(3) liquid chromatographic conditions: filling a chromatographic column with octadecylsilane bonded silica gel; using 0.2% formic acid (A solution)-acetonitrile (B solution) as the mobile phase; setting a gradient elution procedure containing steps of 0 to 2 min in 2% B solution, following 2 to 7 min in 2%˜14% B solution, 7 to 9 min in 14%˜15% B solution, 9 to 11 min in 15%˜16% B solution, 11 to 14 min in 16%˜35 35% B solution, 14 to 16 min in 35% B solution, 16 to 21 min in 35%-70% B solution, 21 to 23 min in 70% B solution, 23 to 28 min in 70%-100% B solution, 28 to 30 min in 100% B solution, volume flow 0.1˜0.4 ml/mi, column temperature 30-35° C., and detection wavelength 230-300 nm;
(4) determination of chromatographic peaks: using the test solution and the standard solution obtained from steps (1) and (2) and the condition descripted in step (3), recording the chromatographic peak within 35 minutes.

2. The fingerprint detection method according to claim 1, characterized that the extraction solution concentration used in the described step (1) is 70% methanol.

3. The fingerprint detection method according to claim 1, wherein in the preparation of the mixed standard solution in the step (2), the concentration of the mulberroside A is 5.05-37.86 μg·mL⁻¹, the concentration of hydroxysafflor yellow A is 4.09-30.71 μg·mL⁻¹, the concentration of paeoniflorin is 50.67-380.0 μg·mL⁻¹, the concentration of ferulic acid is 1.93-14.46 μg·mL⁻¹, the concentration of calycosin-7-glucoside is 0.38-9.38 μgmL⁻¹, the concentration of rosmarinic acid is 4.31-43.07 μg·mL⁻¹, the concentration of salvianolic acid B is 4.71-47.14 μg·mL⁻¹, the concentration of formononetin is 3.57-35.71 μg·mL⁻¹, and the concentration of tanshinone IIA is 1.19-8.93 μg·mL⁻¹.

4. The fingerprint detection method according to claim 1, characterized in that in the liquid chromatography conditions of the described step (3), the column is: ACQUITY UPLC® BEH.

5. The fingerprint detection method according to claim 1, characterized in that in the liquid chromatography conditions of the described step (3), the detection flow rate is 0.2 mL·min⁻¹, the detection wavelength is 254 nm, and the detection column temperature is 35° C.

6. The fingerprint detection method according to claim 1, characterized in that in the fingerprint spectrum generated by the detection method, the fingerprint spectrum of the test solution should show chromatographic peaks with the same retention time as the chromatographic peaks of the standard solution, and the similarity evaluation value of Chinese medicine between the fingerprint spectrum of the test solution and the standard solution should not be less than 0.90.

7. The fingerprint detection method according to claim 1, characterized in that the fingerprint spectrum generated by the detection method comprises 11 peaks including peak 1: mulberroside A, peak 2: hydroxysafflor yellow A, peak 4: paeoniflorin, peak 5: ferulic acid, peak 6: calycosin-7-glucoside, peak 7: rosmarinic acid, peak 8: salvianolic acid B, peak 10, formononetin, and peak 11: tanshinone IIA.

8. The fingerprint detection method according to claim 1, characterized in that pharmaceutical formulation containing 16 ingredients including astragalus, red peony root, salvia miltiorrhiza, Chinese angelica, rhizome of chuanxiong, peach kernel, safflower, frankincense, myrrh, spatholobus stem, achyranthes root, cinnamon twig, mulberry twig, pheretima, scorpion and leech.

9. The fingerprint detection method according to claim 1, characterized in that the composition and dosage ratio of the pharmaceutical preparation comprising 66 parts of astragalus, 27 parts of red peony root, 27 parts of Salvia miltiorrhiza, 27 parts of Chinese angelica, 27 parts of rhizome of chuanxiong, 27 parts of peach kernel, 13 parts of safflower, 13 parts of frankincense, 13 parts of myrrh, 20 parts of spatholobus stem, 27 parts of achyranthes root, 20 parts of cinnamon twig, 27 parts of mulberry twig, 27 parts of pheretima, 13 parts of scorpion and 27 parts of leech.

10. The fingerprint detection method according to claim 1, characterized in that the preparation method of the described pharmaceutical preparation comprising pheretima and scorpion are milled into fine powder, and the other 14 ingredients including astragalus, red peony root, Salvia miltiorrhiza, Chinese angelica, rhizome of chuanxiong, peach kernel, safflower, frankincense, myrrh, spatholobus stem, achyranthes root, cinnamon twig, mulberry twig and leech are crushed into fine powder, and mix the two fine powder and then sieve, encapsulate into capsules.
